(19) United States
(12) Patent Application Publication
(10) Pub. No.: US 2014/0222437 A1
(43) Pub. Date: Aug. 7, 2014

(54) Out-of-Band Notification of Muting During Voice Activity

(71) Applicant: PLANTRONICS, INC., Santa Cruz, CA (US)

(72) Inventors: Joe Burton, Los Gatos, CA (US); Shantanu Sarkar, San Jose, CA (US); Michael Gjerstad, Scotts Valley, CA (US); Richard A. Dunning, JR., Santa Cruz, CA (US)

(73) Assignee: PLANTRONICS, INC., Santa Cruz, CA (US)

(21) Appl. No.: 13/757,650

(22) Filed: Feb. 1, 2013

(51) Int. Cl. G10L 15/22

(52) U.S. Cl. CPC G10L 15/22
USPC 704/278

(57) ABSTRACT

Apparatus having corresponding methods and computer-readable media comprise: a muter configured to pass or block an audio signal; a voice activity detector configured to detect voice activity in the audio signal; and a vibrator configured to produce a mechanical vibration responsive to the contemporaneous occurrence of i) the voice activity detector detecting the voice activity in the audio signal; and ii) the muter being configured to block the audio signal.

### FIELD

The present disclosure relates generally to telecommunications. More particularly, the present disclosure relates to muting during voice activity.

### BACKGROUND

Communication devices such as telephones and the like typically provide a muter that allows a user to prevent transmission of audio from the communication device. For example, a call participant may activate the muter during a telephone call to conduct a private conversation. The call participant can then deactivate the muter to continue the telephone call.

Users often forget the status of their muters. For example, when a call participant wrongly believes his muter is active, he may accidentally convey private comments to the other call participants. Alternatively, when a first call participant wrongly believes his muter is inactive, the other call participants cannot hear what the first call participant says, which may require the first call participant to repeat his comments, possibly causing delay and confusion on the call.

One conventional solution provides an in-band mute status notification to a call participant who is speaking although his muter is active. That is, the notification is provided to the call participant as an audible signal or message, along with the audio of the call. One disadvantage of this approach is that the notification obscures some portion of the audio of the call.

### SUMMARY

In general, in one aspect, an embodiment features an apparatus comprising: a muter configured to pass or block an audio signal; a voice activity detector configured to detect voice activity in the audio signal; and a vibrator configured to produce a mechanical vibration responsive to the contemporaneous occurrence of i) the voice activity detector detecting the voice activity in the audio signal; and ii) the muter being configured to block the audio signal.

Embodiments of the apparatus can include one or more of the following features. Some embodiments comprise a visual device configured to produce a visual notification responsive to the contemporaneous occurrence of i) the voice activity detector detecting the voice activity in the audio signal; and ii) the muter being configured to block the audio signal. In some embodiments, the visual device comprises at least one of: i) a light source, wherein the visual notification comprises a presence or absence of light produced by the light source; and ii) a display device, wherein the visual notification comprises a message displayed on the display device. In some embodiments, the muter comprises a first muter configured to block the audio signal, and a second muter configured to block the audio signal; and the message indicates at least one of i) the first muter is configured to block the audio signal, and ii) the second muter is configured to block the audio signal. Some embodiments comprise a transmitter configured to transmit a notification message to a further apparatus responsive to at least one of i) the voice activity detector detecting the voice activity in the audio signal; and ii) the muter being configured to block the audio signal. Some embodiments comprise a muter interface configured to control the muter in accordance with user input. Some embodiments comprise a transmitter configured to transmit the audio signal while the muter is configured to pass the audio signal. Some embodiments comprise a receiver; and a speaker; wherein the audio signal is a first audio signal; and wherein the receiver is configured to i) receive a second audio signal, and ii) provide the second audio signal to the speaker. Some embodiments comprise an electronic device comprising the apparatus. In some embodiments, the electronic device is selected from the group consisting of: a headset; a mobile phone; a desk phone; and a softphone.

In general, in one aspect, an embodiment features a method comprising: passing or blocking an audio signal; detecting voice activity in the audio signal; and producing a mechanical vibration responsive to the contemporaneous occurrence of i) detecting the voice activity in the audio signal, and ii) blocking the audio signal.

Embodiments of the method can include one or more of the following features. Some embodiments comprise producing a visual notification responsive to the contemporaneous occurrence of i) detecting the voice activity in the audio signal, and ii) blocking the audio signal. In some embodiments, producing a visual notification comprises at least one of: i) providing a presence or absence of light produced by a light source; and ii) displaying a message on a display device. In some embodiments, passing or blocking the audio signal comprises passing or blocking the audio signal at a first device, and passing or blocking the audio signal at a second device; and the message indicates at least one of i) the audio signal is blocked at the first device, and ii) the audio signal is blocked at the second device. Some embodiments comprise transmitting a notification message responsive to at least one of i) detecting the voice activity in the audio signal, and ii) blocking the audio signal. Some embodiments comprise controlling passing or blocking the audio signal in accordance with user input. Some embodiments comprise transmitting the first audio signal responsive to passing the audio signal. In some embodiments, the audio signal is a first audio signal, and the method further comprises: receiving a second audio signal; and providing the second audio signal to a speaker.

In general, in one aspect, an embodiment features computer-readable media embodying instructions executable by a first computer to perform functions comprising: detecting whether an audio signal is being passed or blocked; detecting voice activity in the audio signal; and causing a mechanical vibration responsive to the contemporaneous occurrence of i) detecting the voice activity in the audio signal, and ii) detecting the audio signal is being blocked.

Embodiments of the computer-readable media can include one or more of the following features. In some embodiments, the functions further comprise: causing a visual notification responsive to the contemporaneous occurrence of i) detecting the voice activity in the audio signal, and ii) detecting the audio signal is being blocked. In some embodiments, causing a visual notification comprises at least one of: causing a presence or absence of light produced by a light source; and causing a message to be displayed on a display device. In some embodiments, detecting whether the audio signal is being passed or blocked comprises detecting whether the audio signal is being passed or blocked at a first device, and detecting whether the audio signal is being passed or blocked at a second device; and wherein the message indicates at least one of i) the audio signal is being blocked at the first device, and ii) the audio signal is being blocked at the second device. In some embodiments, the functions further comprise: transmitting a notification message responsive to at least one of i) detecting the voice activity in the audio signal, and ii) detecting the audio signal is being blocked.

The details of one or more implementations are set forth in the accompanying drawings and the description below. Other features will be apparent from the description and drawings, and from the claims.

### DESCRIPTION OF DRAWINGS

FIG. 1 shows elements of an out-of-band muting notification system according to some embodiments of the present disclosure.

FIG. 2 shows a process for the out-of-band muting notification system of FIG. 1 according to some embodiments of the present disclosure.

FIG. 3 shows elements of a headset according to some embodiments of the present disclosure.

FIG. 4 shows elements of a smartphone according to some embodiments of the present disclosure.

FIG. 5 shows elements of a communication system that includes a headset and a smartphone according to some embodiments of the present disclosure.

FIG. 6 shows elements of a communication system that includes a headset, a phone, and a conference bridge according to some embodiments of the present disclosure.

The leading digit(s) of each reference numeral used in this specification indicates the number of the drawing in which the reference numeral first appears.

### DETAILED DESCRIPTION

Embodiments of the present disclosure provide out-of-band notification of muting during voice activity. For example, when a call participant speaks while his phone is muted, an out-of-band notification is provided to the call participant. In some embodiments, the out-of-band notification includes mechanical vibration. For example, when a call participant speaks while his phone is muted, the phone vibrates. In some embodiments, the out-of-band notification includes visual notification. For example, when a call participant speaks while his phone is muted, the phone can display a suitable message, graphical image, and the like, to notify the call participant that he is speaking while his phone is muted. Now several embodiments are described. It will be appreciated that other embodiments can be implemented by combining the features of the described embodiments.

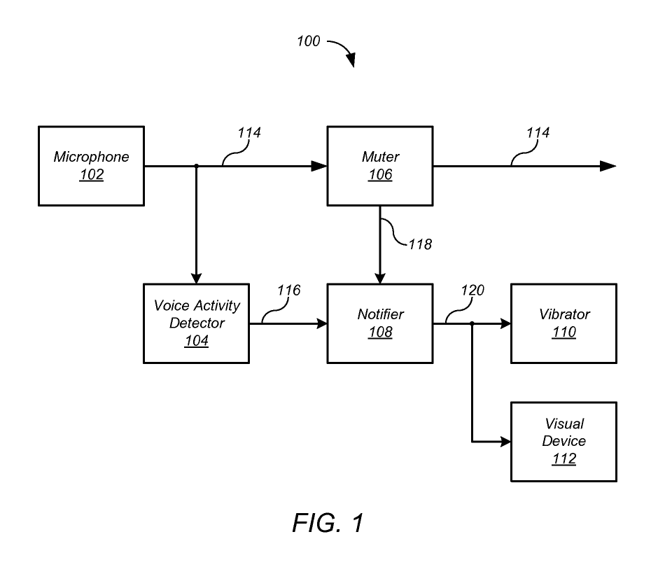

FIG. 1 shows elements of an out-of-band muting notification system 100 according to some embodiments of the present disclosure. Although in the described embodiments, the elements of the out-of-band muting notification system 100 are presented in one arrangement, other embodiments may feature other arrangements, as will be apparent to one skilled in the relevant arts based on the disclosure and teachings provided herein. For example, the elements of the out-of-band muting notification system 100 can be implemented in hardware, software, or combinations thereof.

Referring now to FIG. 1, the out-of-band muting notification system 100 includes a microphone (MIC) 102, a voice activity detector 104, a muter 106, a notifier 108, a vibrator 110, and a visual device 112. The voice activity detector 104, the muter 106, and the notifier 108 can be implemented as one or more electronic circuits. One or more of the electronic circuits can be implemented as one or more integrated circuits, one or more processors, and the like. The vibrator 110 can be implemented as an electronic device, as an electro-mechanical device, or the like. The visual device 112 can be implemented as one or more light sources such as light-emitting diodes (LEDs), a display device such as a display screen, and the like.

In some embodiments, all of the elements of the out-of-band muting notification system 100 are implemented in a single electronic communication device such as a headset, a desk phone, a mobile phone such as a smartphone, a softphone, and the like. The softphone can be implemented as a computer executing a softphone application, a browser-based softphone, other communication mechanisms such as Web Real-Time Communication (webRTC), and the like. In other embodiments, the elements of the out-of-band muting notification system 100 are distributed among multiple electronic devices. For example, in some embodiments, the muter is implemented in a headset, while the display device is implemented in a smartphone having a wireless connection to the headset.

In some embodiments, multiple instances of one or more of the elements of the out-of-band muting notification system 100 are employed. For example, in some embodiments, the muter 106 includes multiple muters, with a first muter 106 implemented in a headset, and a second muter 106 implemented in a smartphone having a wireless connection to the headset. As another example, in some embodiments, a first visual device 112 is implemented in a headset, while a second visual device 112 is implemented in a smartphone having a wireless connection to the headset.

In embodiments having multiple muters 106, the out-of-band muting notification can identify which muter 106 is active. For example, in some embodiments, the visual device 112 is a display screen the displays a message that identifies which muter 106 is active. In some embodiments, the visual device 112 is an LED that identifies which muter 106 is active using a corresponding flashing pattern. In some embodiments, the vibrator 110 identifies which muter 106 is active using a corresponding vibration pattern. In some embodiments, the visual device 112 includes multiple LEDs, with each LED corresponding to a respective muter 106.

In some embodiments, each electronic device includes both a muter 106 and a vibrator 110 and/or a visual device 112. In such embodiments, the vibrator 110 and/or the visual device 112 in the muted device provides the notification. For example, when a call participant is using a headset having a wireless connection to a smartphone, where both the headset and the smartphone include respective muters 106 and vibrators 110, only the vibrator 110 in the device having the active muter 106 vibrates.

Some embodiments include both the vibrator 110 and the visual device 112. Some embodiments include the vibrator 110, but not the visual device 112. Other embodiments include the visual device 112, but not the vibrator 110.

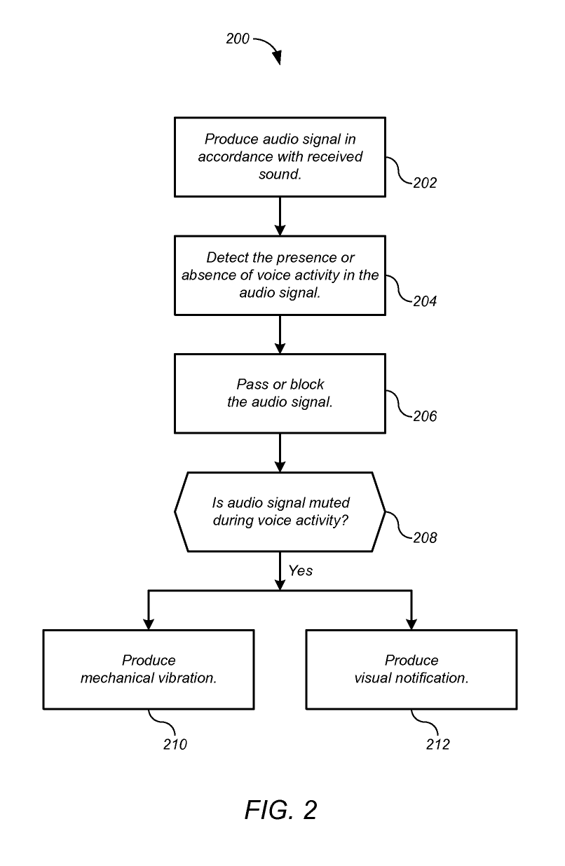

FIG. 2 shows a process 200 for the out-of-band muting notification system 100 of FIG. 1 according to some embodiments of the present disclosure. Although in the described embodiments, the elements of the process 200 are presented in one arrangement, other embodiments may feature other arrangements, as will be apparent to one skilled in the relevant arts based on the disclosure and teachings provided herein. For example, in various embodiments, some or all of the elements of the process 200 can be executed in a different order, concurrently, and the like.

Referring now to FIG. 2, at 202, the microphone 102 produces an audio signal 114 in accordance with sound received by the microphone 102. At 204, voice activity detector 104 detects the presence or absence of voice activity in the audio signal 114. The voice activity detector 104 also generates a voice activity signal 116 that represents the detected presence or absence of voice activity. For example, the voice activity signal 116 can be a bi-level signal where one level indicates a presence of voice activity, and the other level indicates an absence of voice activity. The voice activity detector 104 can be implemented so as to distinguish voice activity from other sorts of sounds.

At 206, the muter 106 either passes or blocks the audio signal 114, for example in accordance with user input, for example such as operation of a mute button. The muter 106 also generates a mute status signal 118 that indicates whether the muter 106 is currently passing or blocking the audio signal 114. For example, the mute status signal 118 can be a bi-level signal where one level indicates muting (that is, the muter 106 is blocking the audio signal 114), and the other level indicates no muting (that is, the muter 106 is passing the audio signal 114).

At 208, the notifier 108 determines whether the audio signal 114 is muted during the presence of voice activity. In particular, the notifier 108 provides a notification signal 120 based on the voice activity signal 116 and the mute status signal 118. The notifier 108 provides the notification signal 120 responsive to the contemporaneous occurrence of i) the voice activity signal 116 indicating the presence of voice activity, and ii) the mute status signal 118 indicating muting. For example, the notification signal 120 can be a bi-level signal where one level indicates that the audio signal 114 is muted during the presence of voice activity.

At 210, if the audio signal 114 is muted during the presence of voice activity, the vibrator 110 produces a mechanical vibration. In particular, the vibrator 110 produces the mechanical vibration responsive to the notification signal 120 indicating that the audio signal 114 is muted during the presence of voice activity.

At 212, if the audio signal 114 is muted during the presence of voice activity, the visual device 112 produces a visual notification. In particular, the visual device 112 produces the visual notification responsive to the notification signal 120 indicating that the audio signal 114 is muted during the presence of voice activity. For example, when the visual device 112 is implemented as a light source such as an LED or the like, the visual notification can be a presence or absence of light produced by the light source. As another example, when the visual device 112 is implemented as a display device, the visual notification can be a message, graphical image, or the like, displayed on the display device.

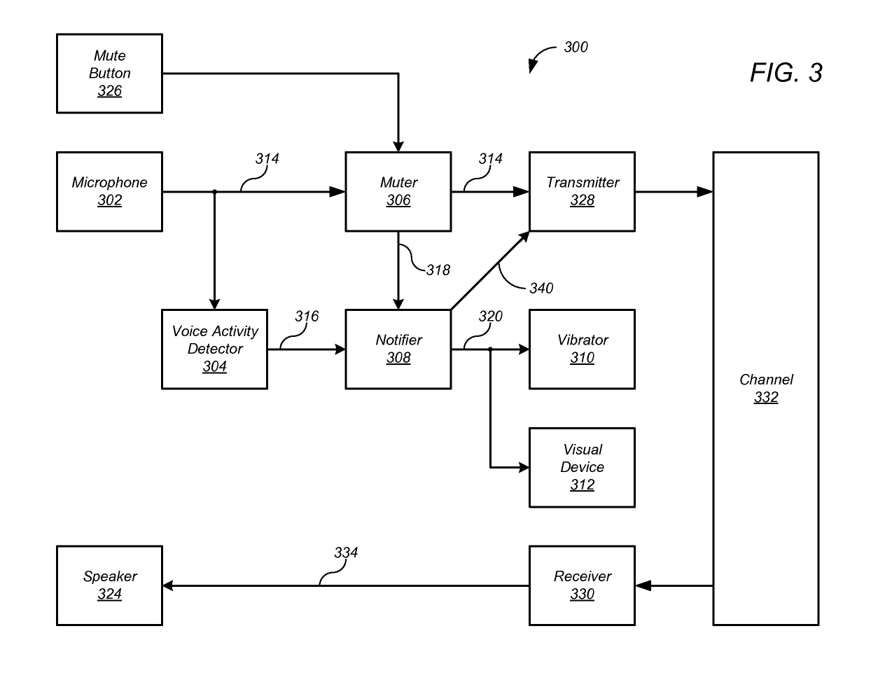

Some embodiments are implemented as headsets. FIG. 3 shows elements of a headset 300 according to some embodiments of the present disclosure. Although in the described embodiments, the elements of the headset 300 are presented in one arrangement, other embodiments may feature other arrangements, as will be apparent to one skilled in the relevant arts based on the disclosure and teachings provided herein. For example, the elements of the headset 300 can be implemented in hardware, software, or combinations thereof.

Referring now to FIG. 3, the headset 300 includes a microphone 302, a voice activity detector 304, a muter 306, a notifier 308, a vibrator 310, and a visual device 312. The headset 300 further includes a speaker 324, a mute button 326, a transmitter 328, and a receiver 330. The voice activity detector 304, the muter 306, the notifier 308, the transmitter 328, and the receiver 330 can be implemented as one or more electronic circuits. One or more of the electronic circuits can be implemented as one or more integrated circuits, one or more processors, and the like. The vibrator 310 can be implemented as an electronic device, as an electro-mechanical device, or the like. The transmitter 328 and the receiver 330 exchange signals with one or more other devices (not shown) over a channel 332. The channel 332 can be implemented as a wired channel or a wireless channel. In one embodiment, the channel 332 is implemented as a Bluetooth channel.

In operation, the microphone 302 produces an output audio signal 314 in accordance with sound received by the microphone 302. When not muted, muter 306 passes the audio signal 314 to the transmitter 328. The transmitter 328 transmits signals that represent the audio signal 314 over the channel 332. Receiver 330 receives signals over the channel 332 that represent an input audio signal 334, and provides the input audio signal 334 to the speaker 324. The speaker 324 produces sound responsive to the input audio signal 334.

A user can control the muter 306 using the mute button 326. The muter 306 either passes or blocks the output audio signal 314, and generates a mute status signal 318 that indicates whether the muter 306 is currently passing or blocking the output audio signal 314, for example as described above. The voice activity detector 304 detects voice activity in the output audio signal 314, and generates a voice activity signal 316 that represents the detected voice activity, for example as described above.

The notifier 308 provides a notification signal 320 based on the voice activity signal 316 and the mute status signal 318. In particular, the notifier 308 provides the notification signal 320 responsive to the contemporaneous occurrence of i) the voice activity signal 316 indicating the presence of voice activity, and ii) the mute status signal 318 indicating muting. Responsive to the notification signal 320, the vibrator 310 produces a mechanical vibration, and the visual device 312 produces a visual notification, thereby alerting the user of the headset 300 that he is speaking while the headset is muted.

In some embodiments, the notifier 308 provides a notification message 340 to the transmitter 328 based on the voice activity signal 316 and/or the mute status signal 318. The notification message 340 indicates the mute status and/or the voice activity status of the headset 300. The transmitter 328 transmits the notification message 340 over channel 332, thereby allowing other devices to generate alerts.

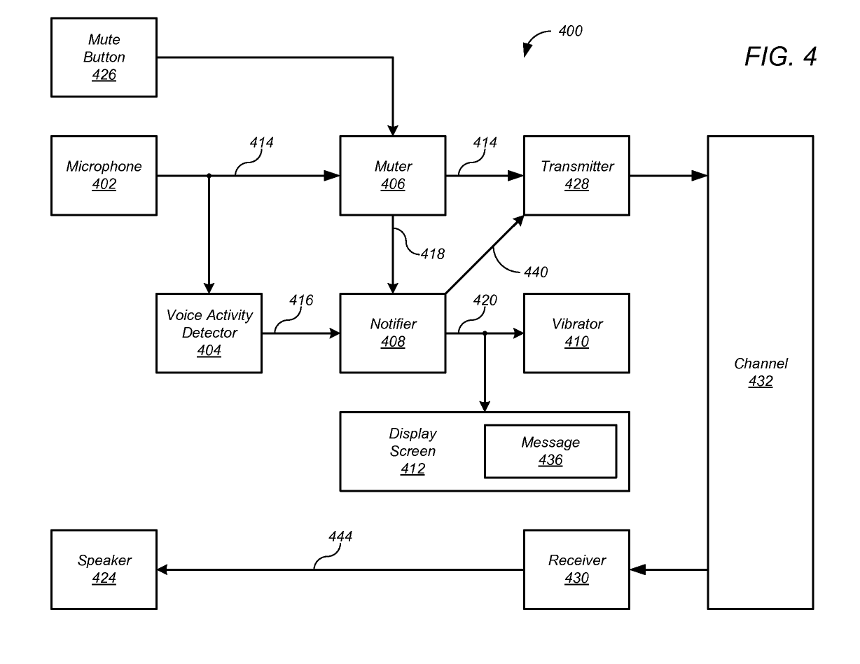

Some embodiments are implemented as smartphones. FIG. 4 shows elements of a smartphone 400 according to some embodiments of the present disclosure. Although in the described embodiments, the elements of the smartphone 400 are presented in one arrangement, other embodiments may feature other arrangements, as will be apparent to one skilled in the relevant arts based on the disclosure and teachings provided herein. For example, the elements of the smartphone 400 can be implemented in hardware, software, or combinations thereof.

Referring now to FIG. 4, the smartphone 400 includes a microphone 402, a voice activity detector 404, a muter 406, a notifier 408, a vibrator 410, and a display screen 412. The smartphone 400 further includes a speaker 424, a mute button 426, a transmitter 428, and a receiver 430. The mute button 426 can be implemented as a mechanical button, soft button, or the like. The voice activity detector 404, the muter 406, the notifier 408, the transmitter 428, and the receiver 430 can be implemented as one or more electronic circuits. One or more of the electronic circuits can be implemented as one or more integrated circuits, one or more processors, and the like. The vibrator 410 can be implemented as an electronic device, as an electro-mechanical device, or the like. The transmitter 428 and the receiver 430 exchange signals with one or more other devices (not shown) over a channel 432. In one embodiment, the channel 432 is implemented as a wireless mobile phone communications channel.

In operation, the microphone 402 produces an output audio signal 414 in accordance with sound received by the microphone 402. When not muted, muter 406 passes the audio signal 414 to the transmitter 428. Transmitter 428 transmits signals that represent the audio signal 414 over the channel 432. Receiver 430 receives signals over the channel 432 that represent an input audio signal 434, and provides the input audio signal 434 to the speaker 424. Speaker 424 produces sound responsive to the input audio signal 434.

A user can control the muter 406 using the mute button 426. The muter 406 either passes or blocks the output audio signal 414, and generates a mute status signal 418 that indicates whether the muter 406 is currently passing or blocking the output audio signal 414, for example as described above. The voice activity detector 404 detects voice activity in the output audio signal 414, and generates a voice activity signal 416 that represents the detected voice activity, for example as described above.

The notifier 408 provides a notification signal 420 based on the voice activity signal 416 and the mute status signal 418. In particular, the notifier 408 provides the notification signal 420 responsive to the contemporaneous occurrence of i) the voice activity signal 416 indicating the presence of voice activity, and ii) the mute status signal 418 indicating muting. Responsive to the notification signal 420, the vibrator 410 produces a mechanical vibration. Responsive to the notification signal 420, the display screen 412 displays a message 436 to alert the user of the smartphone 400 that he is speaking while the smartphone is muted. In some embodiments, the notifier 408 provides a notification message 440 to the transmitter 428 based on the voice activity signal 416 and/or the mute status signal 418. The notification message 440 indicates the mute status and/or the voice activity status of the smartphone 400. The transmitter 428 transmits the notification message 440 over the channel 432, thereby allowing other devices to generate alerts.

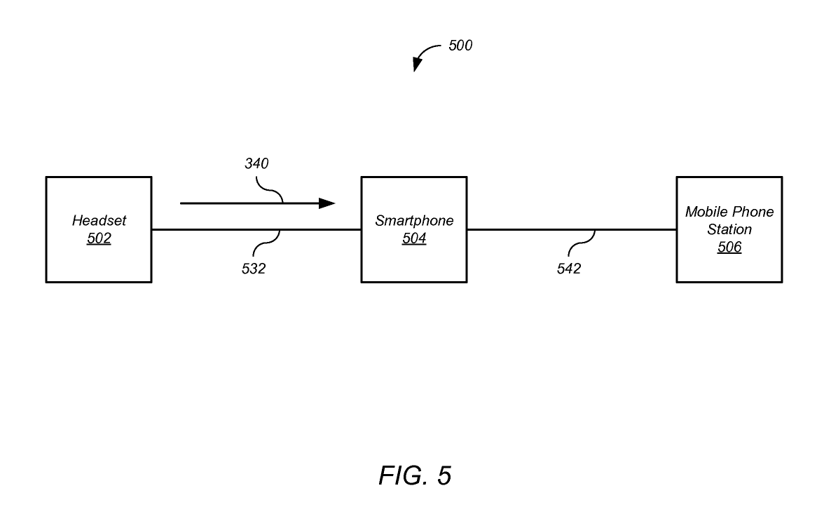

Some embodiments include a headset and a smartphone. FIG. 5 shows elements of a communication system 500 that includes a headset and a smartphone according to some embodiments of the present disclosure. Although in the described embodiments, the elements of the communication system 500 are presented in one arrangement, other embodiments may feature other arrangements, as will be apparent to one skilled in the relevant arts based on the disclosure and teachings provided herein. For example, the elements of the communication system 500 can be implemented in hardware, software, or combinations thereof.

Referring now to FIG. 5, the communication system 500 includes a headset 502, a smartphone 504, and a mobile phone station 506. The headset 502 can be implemented in a manner similar to that of the headset 300 of FIG. 3. The smartphone 504 can be implemented in a manner similar to that of the smartphone 400 of FIG. 4, with the addition of a suitable transceiver for communication with the headset 502. The mobile phone station 506 can be a mobile phone tower or the like.

The headset 502 and the smartphone 504 communicate over a channel 532 such as a Bluetooth channel, a direct wired link, or the like. The smartphone 504 and the mobile phone station 506 communicate over a mobile phone channel 542. According to the present embodiment, the smartphone 504 can indicate that the headset 502 is muted during voice activity, that the smartphone 504 is muted during voice activity, or both, for example by displaying messages on a display screen.

On detecting voice activity, the headset 502 transmits a notification message 340 to the smartphone 504, where the notification message 340 indicates the voice activity. If the smartphone 504 is muted on receiving the notification message 340, the smartphone 504 displays a message indicating the smartphone 504 is muted.

On detecting voice activity while muted, the headset 502 transmits a notification message 340 to the smartphone 504 that indicates the muting and the voice activity. Responsive to the notification message 340, the smartphone 504 displays a message indicating the headset 502 is muted. If the smartphone 504 is muted on receiving the notification message 340, the smartphone 504 also displays a message indicating the smartphone 504 is muted as well.

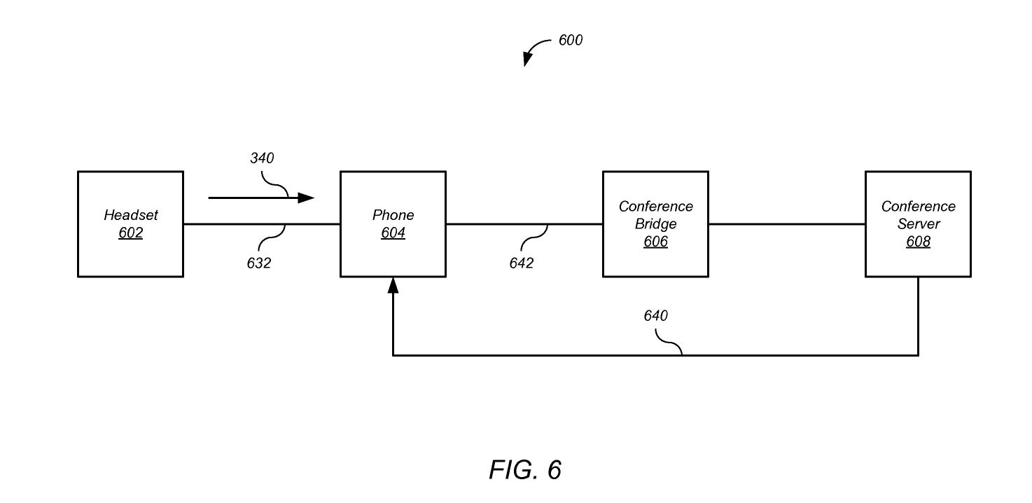

Some embodiments include a headset, a phone, and a conference bridge such as a teleconferencing bridge, videoconferencing bridge, and the like. FIG. 6 shows elements of a communication system 600 that includes a headset, a phone, and a conference bridge according to some embodiments of the present disclosure. Although in the described embodiments, the elements of the communication system 600 are presented in one arrangement, other embodiments may feature other arrangements, as will be apparent to one skilled in the relevant arts based on the disclosure and teachings provided herein. For example, the elements of the communication system 600 can be implemented in hardware, software, or combinations thereof.

Referring now to FIG. 6, the communication system 600 includes a headset 602, a phone 604, a conference bridge 606, and a conference server 608. The headset 602 can be implemented in a manner similar to that of the headset 300 of FIG. 3. The phone 604 can be implemented in a manner similar to that of the smartphone 400 of FIG. 4, with the addition of a suitable transceiver for communication with the headset 602. Alternatively, the phone 604 can be implemented as a desk phone, a mobile phone other than a smartphone, a softphone, and the like. The softphone can be implemented as a computer executing a softphone application, a browser-based softphone, other communication mechanisms such as Web Real-Time Communication (webRTC), and the like.

The headset 602 and the phone 604 communicate over a channel 632 such as a Bluetooth channel, a direct wired link, or the like. The phone 604 and the conference bridge 606 communicate over a channel 642 such as a voice over Internet protocol (VOIP) channel or the like. According to the present embodiment, the phone 604 can indicate that the headset 602 is muted during voice activity, that the phone 604 is muted during voice activity, that the conference bridge 606 is muted during voice activity, or any combination thereof, for example by displaying messages on a display screen.

On detecting voice activity, the headset 602 transmits a notification message 340 to the phone 604, where the notification message 340 indicates the voice activity. If the phone 604 is muted on receiving the notification message 340, the phone 604 displays a message indicating the phone 604 is muted.

On detecting voice activity while muted, the headset 602 transmits a notification message 340 to the phone 604 that indicates the muting and the voice activity. Responsive to the notification message 340, the phone 604 displays a message indicating the headset 602 is muted. If the phone 604 is muted on receiving the notification message 340, the phone 604 also displays a message indicating the phone 604 is muted as well.

The conference bridge 606 can be muted as well, for example by pressing #5 on a keypad of the phone 604. On detecting that the conference bridge 606 is muted, the conference server 608 transmits a notification message 640 to the phone 604, where the notification message 640 indicates the muting. The notification message 640 can be transmitted to the phone 604 by any technique. Example techniques include email messages, text messages, and the like. When the phone 604 determines that the conference bridge 606 is muted while the headset 602, or the phone 604, is reporting voice activity, the phone 604 displays a message indicating the conference bridge 606 is muted.

In some embodiments, the conference is administered by an administrator. In such embodiments, the notification messages 340, 640 can be transmitted to the administrator so the administrator can take appropriate action. In some embodiments, the phone 604 can transmit notification messages 440 to the administrator as well.

Embodiments of the disclosure can be implemented in digital electronic circuitry, or in computer hardware, firmware, software, or in combinations thereof. Embodiments of the disclosure can be implemented in a computer program product tangibly embodied in a machine-readable storage device for execution by a programmable processor; and method steps of the disclosure can be performed by a programmable processor executing a program of instructions to perform functions of the disclosure by operating on input data and generating output. The disclosure can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, one or more ASICs (application-specific integrated circuits), one or more field programmable gate arrays (FPGA), and the like. As used herein, the term module may refer to any of the above implementations.

A number of implementations of the disclosure have been described. Nevertheless, it will be understood that various modifications may be made without departing from the spirit and scope of the disclosure. Accordingly, other implementations are within the scope of the following claims.

What is claimed is:

1. An apparatus comprising:
a muter configured to pass or block an audio signal;
a voice activity detector configured to detect voice activity in the audio signal; and
a vibrator configured to produce a mechanical vibration responsive to the contemporaneous occurrence of
i) the voice activity detector detecting the voice activity in the audio signal; and
ii) the muter being configured to block the audio signal.

2. The apparatus of claim 1, further comprising:
a visual device configured to produce a visual notification responsive to the contemporaneous occurrence of
i) the voice activity detector detecting the voice activity in the audio signal; and
ii) the muter being configured to block the audio signal.

3. The apparatus of claim 2, wherein the visual device comprises at least one of:
i) a light source, wherein the visual notification comprises a presence or absence of light produced by the light source; and
ii) a display device, wherein the visual notification comprises a message displayed on the display device.

4. The apparatus of claim 3, wherein:
the muter comprises
a first muter configured to block the audio signal, and
a second muter configured to block the audio signal; and
the message indicates at least one of
i) the first muter is configured to block the audio signal, and
ii) the second muter is configured to block the audio signal.

5. The apparatus of claim 1, further comprising:
a transmitter configured to transmit a notification message to a further apparatus responsive to at least one of
i) the voice activity detector detecting the voice activity in the audio signal; and
ii) the muter being configured to block the audio signal.

6. The apparatus of claim 1, further comprising:
a muter interface configured to control the muter in accordance with user input.

7. The apparatus of claim 1, further comprising:
a transmitter configured to transmit the audio signal while the muter is configured to pass the audio signal.

8. The apparatus of claim 1, further comprising:
a receiver; and
a speaker;
wherein the audio signal is a first audio signal; and
wherein the receiver is configured to
i) receive a second audio signal, and
ii) provide the second audio signal to the speaker.

9. An electronic device comprising the apparatus of claim 1.

10. The electronic device of claim 9, wherein the electronic device is selected from the group consisting of:
a headset;
a mobile phone;
a desk phone; and
a softphone.

11. A method comprising:
passing or blocking an audio signal;
detecting voice activity in the audio signal; and
producing a mechanical vibration responsive to the contemporaneous occurrence of
i) detecting the voice activity in the audio signal, and
ii) blocking the audio signal.

12. The method of claim 11, further comprising:
producing a visual notification responsive to the contemporaneous occurrence of
i) detecting the voice activity in the audio signal, and
ii) blocking the audio signal.

13. The method of claim 12, further comprising:
wherein producing a visual notification comprises at least one of:
i) providing a presence or absence of light produced by a light source; and
ii) displaying a message on a display device.

14. The method of claim 13, wherein:
passing or blocking the audio signal comprises
passing or blocking the audio signal at a first device, and
passing or blocking the audio signal at a second device; and
wherein the message indicates at least one of
i) the audio signal is blocked at the first device, and
ii) the audio signal is blocked at the second device.

15. The method of claim 11, further comprising:
transmitting a notification message responsive to at least one of
i) detecting the voice activity in the audio signal, and
ii) blocking the audio signal.

16. The method of claim 11, further comprising:
controlling passing or blocking the audio signal in accordance with user input.

17. The method of claim 11, further comprising:
transmitting the first audio signal responsive to passing the audio signal.

18. The method of claim 11, wherein the audio signal is a first audio signal, and
wherein the method further comprises:
receiving a second audio signal; and
providing the second audio signal to a speaker.

19. Computer-readable media embodying instructions executable by a first computer to perform functions comprising:
detecting whether an audio signal is being passed or blocked;
detecting voice activity in the audio signal; and
causing a mechanical vibration responsive to the contemporaneous occurrence of
i) detecting the voice activity in the audio signal, and
ii) detecting the audio signal is being blocked.

20. The computer-readable media of claim 19, wherein the functions further comprise:
causing a visual notification responsive to the contemporaneous occurrence of
i) detecting the voice activity in the audio signal, and
ii) detecting the audio signal is being blocked.

21. The computer-readable media of claim 20, wherein causing a visual notification comprises at least one of:
causing a presence or absence of light produced by a light source; and
causing a message to be displayed on a display device.

22. The computer-readable media of claim 21, wherein:
detecting whether the audio signal is being passed or blocked comprises
detecting whether the audio signal is being passed or blocked at a first device, and
detecting whether the audio signal is being passed or blocked at a second device; and
wherein the message indicates at least one of
i) the audio signal is being blocked at the first device, and
ii) the audio signal is being blocked at the second device.

23. The computer-readable media of claim 19, wherein the functions further comprise:
transmitting a notification message responsive to at least one of
i) detecting the voice activity in the audio signal, and
ii) detecting the audio signal is being blocked.
